(19) United States
(12) Patent Application Publication
(10) Pub. No.: US 2021/0152224 A1
(43) Pub. Date: May 20, 2021

(54) USER TERMINAL AND RADIO COMMUNICATION METHOD

(71) Applicant: NTT DOCOMO, INC., Tokyo (JP)

(72) Inventors: Ryosuke Osawa, Tokyo (JP); Yuichi Kakishima, Tokyo (JP)

(73) Assignee: NTT DOCOMO, INC., Tokyo (JP)

(21) Appl. No.: 16/624,060

(22) PCT Filed: Jun. 23, 2017
(86) PCT No.: PCT/JP2017/023229

§ 371 Date: Dec. 18, 2019

(51) Int. Cl. H04B 7/0456; H04W 72/04

(52) U.S. Cl. CPC H04B 7/0482; H04W 72/0453; H04W 72/042

(57) ABSTRACT

A user terminal according to one aspect of the present invention has a transmitting/receiving section that performs transmitting or receiving processes for signals based on downlink control information, and a control section that decides to use different codebooks for the processes for a plurality of signals. According to one aspect of the present invention, it is possible to switch between and use a number of codebooks, so that the drop in communication throughput and the like can be reduced.

### TECHNICAL FIELD

The present invention relates to a user terminal and a radio communication method in next-generation mobile communication systems.

### BACKGROUND ART

In the Universal Mobile Telecommunications System (UMTS) network, the specifications of long term evolution (LTE) have been drafted for the purpose of further increasing high speed data rates, providing lower latency and so on (see non-patent literature 1). In addition, LTE-A (LTE advanced and LTE Rel. 10, 11, 12 and 13) has been standardized for the purpose of achieving increased capacity and enhancement beyond LTE (LTE Rel. 8 and 9).

Successor systems of LTE are also under study (for example, referred to as “Future Radio Access (FRA),” “5th generation mobile communication system (5G),” “5G+(plus),” “New Radio (NR),” “New radio access (NX),” “Future generation radio access (FX),” “LTE Rel. 14 or 15 and later versions,” etc.).

In LTE, a codebook refers to a pre-determined candidate for a precoding matrix. For example, a user terminal (UE (User Equipment)) selects a precoding matrix that will increase throughput, from a codebook, based on a signal transmitted from a base station (referred to as, for example, an “eNB (evolved Node B),” a “BS (Base Station),” etc.), and transmits its index (Precoding Matrix Indicator (PMI)) as feedback. After that, the base station applies precoding to signals to transmit to the UE, based on the received PMI.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall Description; Stage 2 (Release 8),” April, 2010

### SUMMARY OF INVENTION

### Technical Problem

Envisaging future radio communication systems (for example, NR), research is underway, for example, to support waveforms based on 2 types of communication schemes for the uplink. However, existing LTE has heretofore assumed that a transmitter supports only 1 type of waveform, and no research has been done on the method of using different waveforms and codebooks properly. If there are no adequate rules as to how to use different codebooks properly, the transmitter and the receiver might operate based on different understandings, and this might result in a decline in the quality of communication, a drop in communication throughput, and so forth.

The present invention has been made in view of the above, and it is therefore an object of the present invention to provide a user terminal and a radio communication method, whereby it is possible to switch between and use a number of codebooks, and reduce the drop in communication throughput and the like.

### Solution to Problem

A user terminal according to one aspect of the present invention has a transmitting/receiving section that performs transmitting or receiving processes for signals based on downlink control information, and a control section that decides to use different codebooks for the processes for a plurality of signals.

### Advantageous Effects of Invention

According to the present invention, it is possible to switch between and use a number of codebooks, and reduce the drop in communication throughput and the like.

### BRIEF DESCRIPTION OF DRAWINGS

FIG. 1 is a diagram to show an example of selecting a codebook based on DCI format;

FIG. 2 is a diagram to show another example of selecting a codebook based on DCI format;

FIG. 3 is a diagram to show an exemplary schematic structure of a radio communication system according to one embodiment of the present invention;

FIG. 4 is a diagram to show an exemplary overall structure of a radio base station according to one embodiment of the present invention;

FIG. 5 is a diagram to show an exemplary functional structure of a radio base station according to one embodiment of the present invention;

FIG. 6 is a diagram to show an exemplary overall structure of a user terminal according to one embodiment of the present invention;

FIG. 7 is a diagram to show an exemplary functional structure of a user terminal according to one embodiment of the present invention; and

FIG. 8 is a diagram to show an exemplary hardware structure of a radio base station and a user terminal according to one embodiment of the present invention.

### DESCRIPTION OF EMBODIMENTS

NR is planned to support waveforms based on 2 different communication schemes (which may also be referred to as “multiplexing schemes,” “modulation schemes,” “access schemes,” “waveform schemes,” etc.), at least for the uplink for use for enhanced Mobile Broad Band (eMBB). These 2 types of waveforms are, to be more specific, a waveform based on cyclic prefix OFDM (or “Cyclic Prefix Orthogonal Frequency Division Multiplexing (CP-OFDM)”), or a waveform based on DFT-spread OFDM (or “Discrete Fourier Transform Spread Orthogonal Frequency Division Multiplexing (DFT-S-OFDM)”).

Note that the CP-OFDM waveform may be referred to as a “multi-carrier communication scheme waveform” and the DFT-S-OFDM waveform may be referred to as a “single-carrier communication scheme waveform.” Also, these waveforms may be characterized based on whether or not DFT precoding (spreading) is applied to the OFDM waveform. For example, CP-OFDM may be referred to as the “waveform (signal) to which DFT precoding is not applied,” and DFT-S-OFDM may be referred to as the “waveform (signal) to which DFT precoding is applied.”

NR might switch between and use CP-OFDM and DFT-S-OFDM, so that the waveform might even alter while communication is in progress. For example, the network (such as a base station (also referred to as a “gNB”)) may indicate, to UE, which one of the CP-OFDM-based waveform and the DFT-S-OFDM-based waveform (or to switch the waveform) should be used. This indication may be reported to the UE by higher layer signaling, physical layer signaling (for example, downlink control information (DCI)) or a combination of these.

As for higher layer signaling, for example, Radio Resource Control (RRC) signaling, Medium Access Control (MAC) signaling, (for example, MAC control element (MAC CE (Control Element))), broadcast information (for example, Master Information Block (MIB), System Information Block (SIB), etc.) and the like may be used.

The use of the CP-OFDM waveform and the DFT-S-OFDM waveform in single-stream (single-layer) and multi-stream (multi-layer, Multi Input Multi Output (MIMO), etc.) transmissions is under has been study. However, the DFT-S-OFDM waveform may be used only for single-stream transmission.

Now, in LTE, a codebook refers to a pre-determined candidate for a precoding matrix (or a table to show candidates). For example, an eNB may select, based on a signal transmitted from UE, a precoding matrix that will increases the throughput, out of a codebook, and transmit information about a transmitted precoding matrix indicator (TPMI), as feedback. After that, the UE applies precoding to signals to transmit to the eNB, based on the received TPMI. Codebook-based precoding may also be applied to signals transmitted from the eNB as well.

Envisaging NR, for example, for the uplink, use of different codebooks (codebooks of different types) on a per waveform basis is discussed. For example, discussion is going on to use the codebook for LTE Rel. 8 downlink for CP-OFDM, and to use the codebook for LTE Rel. 10 uplink for DFT-S-OFDM.

However, existing LTE has heretofore assumed that a transmitter supports only 1 type of waveform (a base station transmits the CP-OFDM waveform and UE transmits the DFT-S-OFDM waveform), and no research has been done on the method of using different codebooks properly. If there are no adequate rules as to how to use different codebooks properly, the transmitter and the receiver might operate based on different understandings, and this might result in a decline in the quality of communication, a drop in communication throughput, and so forth.

Therefore, the present inventors have worked on how to use multiple codebooks properly even when multiple waveforms are used for transmission (or receipt), and arrived at the present invention.

Now, embodiments of the present invention will be described below in detail with reference to the accompanying drawings. Note that the radio communication methods according to each embodiment may be applied individually or may be applied in combination. Note that, for ease of explanation, hereinafter, to “transmit and/or receive” will be written simply as to “transmit/receive.”

(Radio Communication Method)

### First Embodiment

According to a first embodiment of the present invention, when DCI is detected, UE switches the codebook to use for the transmission and/or receipt scheduled by this DCI, based on the format of this DCI. Here, DCI to schedule UL transmission may be referred to as “UL grant,” “transmitting grant,” and the like, and DCI to schedule DL receipt may be referred to as “DL assignment,” “receiving grant,” and so on.

The codebooks that may be subject to switching include, for example, the codebook for the downlink of LTE Rel. 8, the codebook for the uplink of LTE Rel. 10 and/or other codebooks.

If the DFT-S-OFDM waveform is limited to single-layer transmission and receipt, no transmitted rank indicator (TRI) is needed to schedule this waveform. Therefore, the CP-OFDM waveform and the DFT-S-OFDM waveform are likely to be controlled using respective DCI formats.

The DCI formats may be associated with waveforms. For example, a given DCI format may be used only when scheduling the transmission and receipt of a specific waveform (for example, either the CP-OFDM waveform or the DFT-S-OFDM waveform), or may be used to schedule the transmission and receipt of a number of waveforms.

The DCI formats may be associated with the numbers of streams (the numbers of layers). For example, a given DCI format may be used only when scheduling the transmission and receipt involving a particular number of layers. The predefined DCI format may be used only for scheduling the transmission and receipt of a single layer (single stream, or the number of layers is 1), may be used only for scheduling the transmission and receipt of multiple layers (multiple streams, the number of multi-streams and layers is n (n>1)), or may be used for scheduling both single-layer and multi-layer transmission and receipt.

The DCI formats may be associated with methods of resource allocation. For example, the given DCI format may be used only for scheduling the transmission and receipt of contiguous resources (for example, PRBs), may be used only for scheduling the transmission and receipt of non-contiguous resources, or may be used for scheduling both contiguous and non-contiguous resources.

The codebooks and DCI formats (and parameters included in DCI) may be linked statically, or may be linked semi-statically or dynamically.

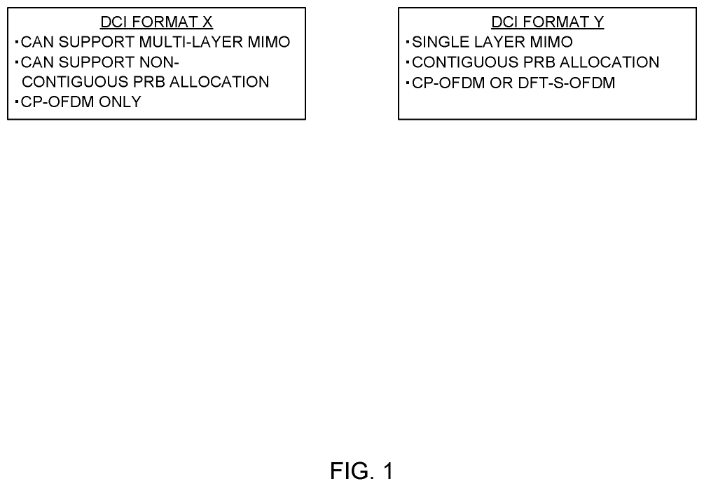

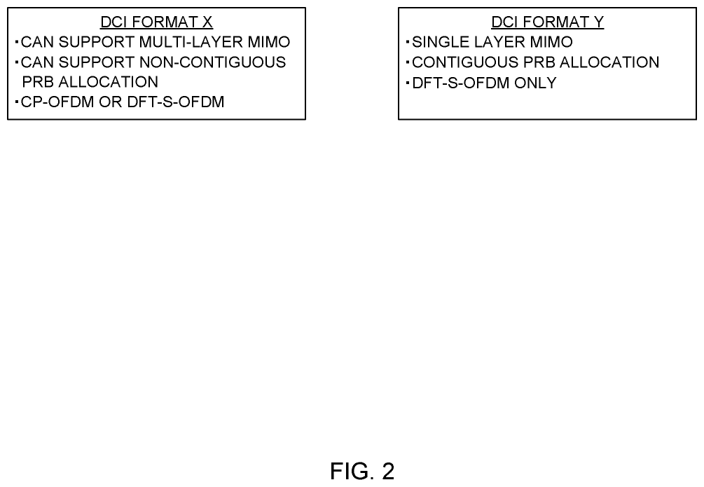

Hereinafter, referring to FIG. 1 and FIG. 2, examples of associations between codebooks and DCI formats will be described. These examples will assume that the CP-OFDM waveform and the DFT-S-OFDM waveform are associated with different codebooks. In this case, UE may specify which codebook is applied to a scheduled signal, based on what waveform is scheduled. Therefore, in the examples of FIG. 1 and FIG. 2, “waveform” may be read as “codebook.”

FIG. 1 is a diagram to show an example of selecting a codebook based on DCI format. In this example, DCI format X can support multi-layer MIMO and non-contiguous PRB allocation, and is a format for scheduling only the CP-OFDM waveform. Also, DCI format Y supports single-layer MIMO and contiguous PRB allocation, and is a format for scheduling at least one of the CP-OFDM waveform and the DFT-S-OFDM waveform.

As an example of the static linking of FIG. 1, the waveform to be scheduled by DCI format Y may be fixed to the DFT-S-OFDM waveform. In this case, DCI format X and DCI format Y correspond, on a one-by-one basis, to the CP-OFDM waveform and the DFT-S-OFDM waveform, respectively, so that the UE can use these codebooks properly depending on the DCI format.

Note that, the CP-OFDM waveform, which is transmitted in single-layer transmission, will be scheduled by DCI format X.

As an example of the semi-static linking of FIG. 1, the waveform to be scheduled by DCI format Y may be configured by higher layer signaling (RRC signaling, SIBs, etc.). Note that, to avoid the situation where which waveform is scheduled by DCI format Y cannot be specified until this configuration is applied, a default waveform to be assumed as the signal to be scheduled by DCI format Y may be defined. The default waveform may be determined by the specification, or based on the numerology or the like related to the carrier in which DCI is detected and/or the scheduled carrier.

Note that the static linking and/or the semi-static linking described above may be ignored for part of the signals. In this case, the waveform to apply to the part of the signals may be specified by dynamic linking, which will be described later, or the default waveform may be selected. The part of the signals may be message 3 in random access (RA) procedures.

For example, DCI format Y is linked semi-statically with the CP-OFDM waveform, and UE may decide to use the DFT-S-OFDM waveform as the waveform for message 3, even if message 3 is scheduled by DCI format Y.

Also, even when static linking and/or the semi-static linking is enabled once a predetermined waveform is scheduled by a given DCI format, part of the signals may be ignored. The UE may assume that the part of the signals is scheduled by a format other than the above given DCI format.

For example, even when a UL signal is linked with the CP-OFDM waveform and scheduled by DCI format X, the UE may judge that message 3 is scheduled by DCI format Y.

As an example of the dynamic linking of FIG. 1, the waveform that is used to transmit and receive a predetermined signal based on certain DCI and the format of this DCI may be associated with each other. For example, the predetermined signal may be message 3. Note that, in the following description, “message 3” may be interpreted as any signal/channel that is used in dynamic linking, and the “UL grant included in the RAR” may be interpreted as the signal that schedules this signal/channel (DCI).

The UL grant for transmitting message 3 is included in message 2 (random access response (RAR)). Assuming that single-layer transmission applies to message 3, the UL grant included in the RAR corresponds to DCI format Y.

The waveform (for example, CP-OFDM waveform or DFT-S-OFDM waveform) that is used to transmit message 3 may be configured in the UE by higher layer signaling (RRC signaling, SIB, etc.), may be determined based on the UL grant included in the RAR, or may be selected based on predetermined rules. At this time, the UE may link the selected waveform with DCI format Y.

The predetermined rules may include, for example, the following:

(1) The DFT-OFDM waveform is used if the transmission of message 3 is power-limited (for example, exceeds the maximum allowable transmission power of the user, exceeds the maximum transmission power of the carrier (cell) to use for the transmission, etc.), and, otherwise the CP-OFDM waveform is used; and

(2) the CP-OFDM waveform is used if the RA procedure is non-contention-based (contention-free), and, otherwise (for example, when the RA procedure is contention-based), the DFT-S-OFDM waveform is used.

Rule (1) above takes into account the fact that DFT-S-OFDM can increase transmission power higher. Also, rule (2) above takes into account preventing switching of the waveform, because, in non-contention-based RA, CP-OFDM is likely to be used before and after message 3 is transmitted. Although, when the waveform is switched, a power headroom report (PHR) is required for the waveform after the switch, if the waveform is not switched, it is not even necessary to calculate a PHR, and the burden of processing can be reduced.

The gNB may perform blind decoding with message 3, assuming both the CP-OFDM waveform and the DFT-S-OFDM waveform, and link the detected waveform with DCI format Y. This allows both the gNB and the UE to share a common understanding of the association of DCI format Y with the waveform.

Note that the gNB may overwrite (configure) the association between DCI format Y and the waveform by using higher layer signaling or the like.

FIG. 2 is a diagram to show another example of selecting a codebook based on DCI format. In this example, DCI format X can support multi-layer MIMO and non-contiguous PRB allocation, and is a format for scheduling at least one of the CP-OFDM waveform and the DFT-S-OFDM waveform. Also, DCI format Y supports single-layer MIMO and contiguous PRB allocation, and is a format for scheduling the DFT-S-OFDM waveform alone.

As an example of the static linking of FIG. 2, the waveform to be scheduled by DCI format X may be fixed to the DFT-S-OFDM waveform. In this case, DCI format X and DCI format Y correspond, on a one-by-one basis, to the CP-OFDM waveform and the DFT-S-OFDM waveform, respectively, so that the UE can use these codebooks properly depending on the DCI format.

Note that the CP-OFDM waveform, which is transmitted in single-layer transmission, is scheduled by DCI format X.

As an example of the semi-static linking of FIG. 2, the waveform to be scheduled by DCI format X may be configured by higher layer signaling (RRC signaling, SIBs, etc.). Note that, to avoid the situation where which waveform is scheduled by DCI format X cannot be specified until this configuration is applied, a default waveform to be assumed as the signal to be scheduled by DCI format X may be defined, as has been described with the example of FIG. 1. Note that the static linking and/or the semi-static linking may be ignored for part of the signals, as has been described with the example of FIG. 1.

Also, in the event the DFT-S-OFDM waveform is configured as being the waveform to be scheduled by DCI format X and, the UE may assume that DCI format X, like DCI format Y, supports only single-layer MIMO and contiguous PRB allocation. Also, in the event the DFT-S-OFDM waveform is configured as being the waveform to be scheduled by DCI format X and DCI format X does not support single-layer MIMO or contiguous PRB allocation, the UE may ignore (does not have to detect) DCI format X.

As an example of the dynamic linking of FIG. 2. similar to the example of FIG. 1, the waveform to use to transmit message 3 may be linked with DCI format X, or the association between DCI format X and the waveform may be overwritten (configured).

According to the first embodiment described above, the codebook to use can be specified based on the DCI format, so that flexible scheduling is made possible.

### Second Embodiment

According to a second embodiment of the present invention, based on a given field contained in DCI that is detected, UE switches the codebook to use for the transmission and/or receipt scheduled by that DCI.

This given field may be equivalent to information that indicates codebooks explicitly (codebook-specifying information). The UE may select a codebook based on the codebook-specifying information included in DCI, and identify the precoding weights to apply to scheduled signals based on the codebook and the transmitted PMI (TPMI) included in the DCI.

Also, the UE may switch the codebook to use based on one or more parameters specified in the given field. For example, the UE may select the codebook to use based on one of the waveform indicated by DCI, the number of streams, the resource allocation method and the TPMI, or based on a combination of these.

To be more specific, part of the given fields (for example, the TPMI field) included in DCI may be used as information to specify codebooks (and/or waveforms). The part of the given fields may be the first n bits, the last n bits (n is 1, 2 . . . ), or the like. Note that it is possible to assume that this codebook (and/or waveform)-specifying information is used only when there are a predetermined number of layers (for example, a single layer), and, in the event there are a different number of layers (for example, multiple layers), different information (for example, information for expanding codebooks) may be used.

Also, when a given field (for example, the TPMI field) shows a specific value (index), this specific value may be used as information to indicate a specific codebook (and/or waveform). For example, the UE may judge that a scheduled signal has the DFT-S-OFDM waveform when the value of a given field is #0 to #7, or judge that a scheduled signal has the CP-OFDM waveform when the value of the given field is #8 or more.

According to the second embodiment described above, the codebook to use can be specified based on the contents of DCI, so that flexible scheduling is made possible.

(Variations)

Codebook-specifying information, such as that described above with the second embodiment, may be reported to UE through non-DCI signaling (for example, higher layer signaling). Therefore, the UE may specify the codebook to use based on non-DCI signaling.

The above embodiments have been described based on the assumption that different codebooks are used per waveform. However, examples to use varying codebooks for the same waveform are also applicable. The use of varying codebooks may be switched based on factors other than waveforms.

For example, the switching of codebooks may be controlled (judged) based on at least one of (1) information about transmission ports (antenna ports) (for example, the number of ports, the resource locations of ports, the number of transmission panels, reference signal resources (for example, the number of sounding reference signal (SRS) resources, etc.)), (2) information about layers (streams, MIMO) (for example, the number of layers, etc.), (3) information about time and/or frequency resources (for example, slot indices, information to distinguish between wideband and subband, etc.), (4) information about beams (for example, beam indices, beam group indices, etc.), (5) information about numerologies (SCS, etc.).

Also, the UE may decide to switch the codebook based on whether or not the parameter corresponding to at least one of the information of (1) to (5) above fulfills a predetermined condition. For example, the UE may decide to use a given codebook (for example, the codebook for the uplink of LTE Rel. 10) when the parameter corresponding to at least one of the information of (1) to (5) above is larger than a predetermined threshold (and/or included in a predetermined range of values).

The UE may select the codebook to use for transmission and receipt based on, for example, whether the number of ports/the number of layers used in transmission/receipt is greater than a predetermined threshold or not, whether the scheduled resource constitutes a wideband or not, whether the beam index/beam group index/SCS is greater than a predetermined threshold or not, and so on.

Note that information to represent (1) to (5) above, information of the above predetermined threshold and information of the above predetermined range may be reported to the UE by higher layer signaling (for example, RRC signaling), physical layer signaling (for example, DCI) or a combination of these.

According to the configurations of the variations described above, even when codebooks do not depend on the waveform, the codebook to use can be specified based on other parameters, so that flexible scheduling is made possible.

(Radio Communication System)

Now, the structure of a radio communication system according to one embodiment of the present invention will be described below. In this radio communication system, communication is performed using one of the radio communication methods according to the herein-contained embodiments of the present invention, or a combination of these.

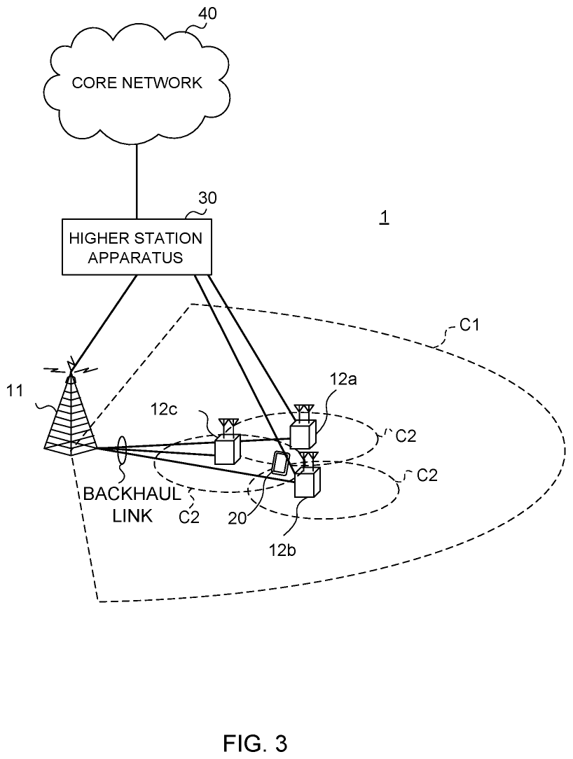

FIG. 3 is a diagram to show an exemplary schematic structure of a radio communication system according to one embodiment of the present invention. A radio communication system 1 can adopt carrier aggregation (CA) and/or dual connectivity (DC) to group a plurality of fundamental frequency blocks (component carriers) into one, where the LTE system bandwidth (for example, 20 MHz) constitutes 1 unit.

Note that the radio communication system 1 may be referred to as “LTE (Long Term Evolution),” “LTE-A (LTE-Advanced),” “LTE-B (LTE-Beyond),” “SUPER 3G,” “IMT-Advanced,” “4th generation mobile communication system (4G),” “5th generation mobile communication system (5G),” “New Radio (NR),” “Future Radio Access (FRA),” “New-RAT (Radio Access Technology),” and so on, or may be seen as a system to implement these.

The radio communication system 1 includes a radio base station 11 that forms a macro cell C1, with a relatively wide coverage, and radio base stations 12a to 12c that are placed within the macro cell C1 and that form small cells C2, which are narrower than the macro cell C1. Also, user terminals 20 are placed in the macro cell C1 and in each small cell C2. The arrangement and number of cells and user terminals 20 are not limited to those illustrated in the drawing.

The user terminals 20 can connect with both the radio base station 11 and the radio base stations 12. The user terminals 20 may use the macro cell C1 and the small cells C2 at the same time by means of CA or DC. Furthermore, the user terminals 20 may apply CA or DC using a plurality of cells (CCs) (for example, five or fewer CCs or six or more CCs).

Between the user terminals 20 and the radio base station 11, communication can be carried out using a carrier of a relatively low frequency band (for example, 2 GHz) and a narrow bandwidth (referred to as, for example, an “existing carrier,” a “legacy carrier” and so on). Meanwhile, between the user terminals 20 and the radio base stations 12, a carrier of a relatively high frequency band (for example, 3.5 GHz, 5 GHz and so on) and a wide bandwidth may be used, or the same carrier as that used in the radio base station 11 may be used. Note that the structure of the frequency band for use in each radio base station is by no means limited to these.

Furthermore, the user terminals 20 can communicate by using time division duplexing (TDD) and/or frequency division duplexing (FDD), in each cell. Furthermore, in each cell (carrier), a single numerology may be used, or a plurality of different numerologies may be used.

A numerology may refer to communication parameters that are applied to transmission and/or receipt of a given signal and/or channel, and may represent at least one of the subcarrier spacing (SCS), the bandwidth, the length of symbols, the length of cyclic prefixes, the length of subframes, the length of TTIs (for example, the length of slots, etc.), the number of symbols per TTI, the radio frame configuration, the filtering process, the windowing process and so on.

The radio base station 11 and a radio base station 12 (or 2 radio base stations 12) may be connected with each other by cables (for example, by optical fiber, which is in compliance with the CPRI (Common Public Radio Interface), the X2 interface and so on), or by radio.

The radio base station 11 and the radio base stations 12 are each connected with higher station apparatus 30, and are connected with a core network 40 via the higher station apparatus 30. Note that the higher station apparatus 30 may be, for example, access gateway apparatus, a radio network controller (RNC), a mobility management entity (MME) and so on, but is by no means limited to these. Also, each radio base station 12 may be connected with the higher station apparatus 30 via the radio base station 11.

Note that the radio base station 11 is a radio base station having a relatively wide coverage, and may be referred to as a “macro base station,” a “central node,” an “eNodeB (eNB),” a “transmitting/receiving point” and so on. Also, the radio base stations 12 are radio base stations having local coverages, and may be referred to as “small base stations,” “micro base stations,” “pico base stations,” “femto base stations,” “Home eNodeBs (HeNBs),” “Remote Radio Heads (RRHs),” “transmitting/receiving points” and so on. Hereinafter the radio base stations 11 and 12 will be collectively referred to as “radio base stations 10,” unless specified otherwise.

The user terminals 20 are terminals to support various communication schemes such as LTE, LTE-A and so on, and may be either mobile communication terminals (mobile stations) or stationary communication terminals (fixed stations).

In the radio communication system 1, as radio access schemes, orthogonal frequency division multiple access (OFDMA) is applied to the downlink, and single-carrier frequency division multiple access (SC-FDMA) and/or OFDMA are applied to the uplink.

OFDMA is a multi-carrier communication scheme to perform communication by dividing a frequency bandwidth into a plurality of narrow frequency bandwidths (subcarriers) and mapping data to each subcarrier. SC-FDMA is a single-carrier communication scheme to mitigate interference between terminals by dividing the system bandwidth into bands formed with one or continuous resource blocks per terminal, and allowing a plurality of terminals to use mutually different bands. Note that, uplink and downlink radio access schemes are not limited to these combinations, and other radio access schemes may be used.

In the radio communication system 1, a downlink shared channel (Physical Downlink Shared CHannel (PDSCH)), which is used by each user terminal 20 on a shared basis, a broadcast channel (Physical Broadcast CHannel (PBCH)), downlink L1/L2 control channels and so on are used as downlink channels. User data, higher layer control information, System Information Blocks (SIBs) and so on are communicated in the PDSCH. Also, the Master Information Blocks (MIB) is communicated in the PBCH.

The downlink L1/L2 control channels include a Physical Downlink Control CHannel (PDCCH), an Enhanced Physical Downlink Control CHannel (EPDCCH), a Physical Control Format Indicator CHannel (PCFICH), a Physical Hybrid-ARQ Indicator CHannel (PHICH) and so on. Downlink control information (DCI), which includes PDSCH and/or PUSCH scheduling information, is communicated by the PDCCH.

Note that scheduling information may be reported in DCI. For example, DCI to schedule receipt of DL data may be referred to as a “DL assignment,” and DCI to schedule UL data transmission may also be referred to as a “UL grant.”

The number of OFDM symbols to use for the PDCCH is communicated by the PCFICH. Hybrid Automatic Repeat reQuest (HARQ) delivery acknowledgment information (also referred to as, for example, “retransmission control information,” “HARQ-ACKs,” “ACK/NACKs,” etc.) in response to the PUSCH is transmitted by the PHICH. The EPDCCH is frequency-division-multiplexed with the PDSCH (downlink shared data channel) and used to communicate DCI and so on, like the PDCCH.

In the radio communication system 1, an uplink shared channel (Physical Uplink Shared CHannel (PUSCH)), which is used by each user terminal 20 on a shared basis, an uplink control channel (Physical Uplink Control CHannel (PUCCH)), a random access channel (Physical Random Access CHannel (PRACH)) and so on are used as uplink channels. User data, higher layer control information and so on are communicated by the PUSCH. Also, in the PUCCH, downlink radio quality information (Channel Quality Indicator (CQI)), delivery acknowledgment information, scheduling requests (SRs) and so on are communicated. By means of the PRACH, random access preambles for establishing connections with cells are communicated.

In the radio communication system 1, cell-specific reference signals (CRSs), channel state information reference signals (CSI-RSs), demodulation reference signals (DMRSs), positioning reference signals (PRSs) and so on are communicated as downlink reference signals. Also, in the radio communication system 1, measurement reference signals (Sounding Reference Signals (SRSs)), demodulation reference signals (DMRSs) and so on are communicated as uplink reference signals. Note that the DMRSs may be referred to as “user terminal-specific reference signals (UE-specific reference signals).” Also, the reference signals to be communicated are by no means limited to these.

(Radio Base Station)

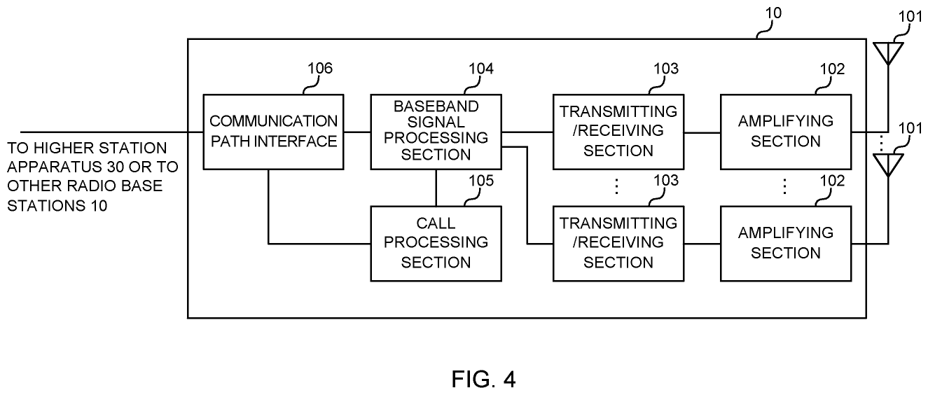

FIG. 4 is a diagram to show an exemplary overall structure of a radio base station according to one embodiment of the present invention. A radio base station 10 has a plurality of transmitting/receiving antennas 101, amplifying sections 102, transmitting/receiving sections 103, a baseband signal processing section 104, a call processing section 105 and a communication path interface 106. Note that one or more transmitting/receiving antennas 101, amplifying sections 102 and transmitting/receiving sections 103 may be provided.

User data to be transmitted from the radio base station 10 to a user terminal 20 on the downlink is input from the higher station apparatus 30 to the baseband signal processing section 104, via the communication path interface 106.

In the baseband signal processing section 104, the user data is subjected to transmission processes, including a Packet Data Convergence Protocol (PDCP) layer process, user data division and coupling, Radio Link Control (RLC) layer transmission processes such as RLC retransmission control, Medium Access Control (MAC) retransmission control (for example, an Hybrid Automatic Repeat reQuest (HARD) transmission process), scheduling, transport format selection, channel coding, an inverse fast Fourier transform (IFFT) process and a precoding process, and the result is forwarded to each transmitting/receiving section 103. Furthermore, downlink control signals are also subjected to transmission processes such as channel coding and an inverse fast Fourier transform, and forwarded to each transmitting/receiving section 103.

Baseband signals that are pre-coded and output from the baseband signal processing section 104 on a per antenna basis are converted into a radio frequency band in the transmitting/receiving sections 103, and then transmitted. The radio frequency signals having been subjected to frequency conversion in the transmitting/receiving sections 103 are amplified in the amplifying sections 102, and transmitted from the transmitting/receiving antennas 101. The transmitting/receiving sections 103 can be constituted by transmitters/receivers, transmitting/receiving circuits or transmitting/receiving apparatus that can be described based on general understanding of the technical field to which the present invention pertains. Note that a transmitting/receiving section 103 may be structured as a transmitting/receiving section in one entity, or may be constituted by a transmitting section and a receiving section.

Meanwhile, as for uplink signals, radio frequency signals that are received in the transmitting/receiving antennas 101 are each amplified in the amplifying sections 102. The transmitting/receiving sections 103 receive the uplink signals amplified in the amplifying sections 102. The received signals are converted into the baseband signal through frequency conversion in the transmitting/receiving sections 103 and output to the baseband signal processing section 104.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing (such as setting up and releasing communication channels), manages the state of the radio base stations 10 and manages the radio resources.

The communication path interface section 106 transmits and receives signals to and from the higher station apparatus 30 via a predetermined interface. Also, the communication path interface 106 may transmit and receive signals (backhaul signaling) with other radio base stations 10 via an inter-base station interface (which is, for example, optical fiber that is in compliance with the Common Public Radio Interface (CPRI), the X2 interface, etc.).

The transmitting/receiving sections 103 perform receiving processes for signals transmitted from the user terminal 20, or performs transmission processes for signals received at the user terminal 20, based on downlink control information (UL grant, DL assignment, etc.).

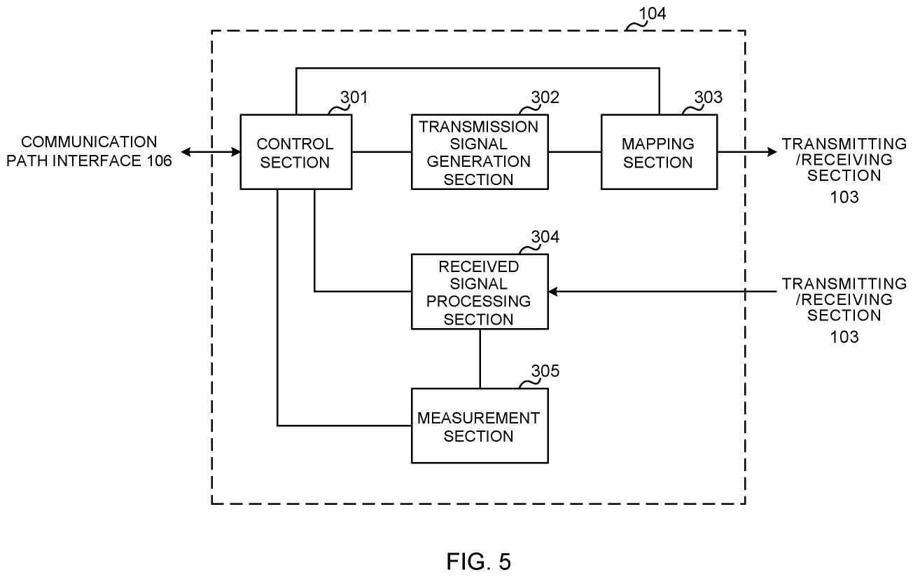

FIG. 5 is a diagram to show an exemplary functional structure of a radio base station according to one embodiment of the present invention. Note that, although this example primarily shows functional blocks that pertain to characteristic parts of the present embodiment, the radio base station 10 has other functional blocks that are necessary for radio communication as well.

The baseband signal processing section 104 at least has a control section (scheduler) 301, a transmission signal generation section 302, a mapping section 303, a received signal processing section 304 and a measurement section 305. Note that these configurations have only to be included in the radio base station 10, and some or all of these configurations may not be included in the baseband signal processing section 104.

The control section (scheduler) 301 controls the whole of the radio base station 10. The control section 301 can be constituted by a controller, a control circuit or control apparatus that can be described based on general understanding of the technical field to which the present invention pertains.

The control section 301 controls, for example, generation of signals in the transmission signal generation section 302, allocation of signals in the mapping section 303, and so on. Furthermore, the control section 301 controls signal receiving processes in the received signal processing section 304, measurements of signals in the measurement section 305, and so on.

The control section 301 controls the scheduling (for example, resource allocation) of system information, downlink data signals (for example, signals transmitted in the PDSCH) and downlink control signals (for example, signals transmitted in the PDCCH and/or the EPDCCH, such as delivery acknowledgment information). Also, the control section 301 controls the generation of downlink control signals, downlink data signals and so on, based on the results of deciding whether or not retransmission control is necessary for uplink data signals, and so on. Also, the control section 301 controls the scheduling of synchronization signals (for example, the Primary Synchronization Signal (PSS)/Secondary Synchronization Signal (SSS)), downlink reference signals (for example, the CRS, the CSI-RS, the DMRS, etc.) and so on.

The control section 301 also controls the scheduling of uplink data signals (for example, signals transmitted in the PUSCH), uplink control signals (for example, signals transmitted in the PUCCH and/or the PUSCH, such as delivery acknowledgment information), random access preambles (for example, signals transmitted in the PRACH), and uplink reference signals.

The control section 301 may decide to use different codebooks for transmission or receiving processes for multiple signals. These signals may be, for example, signals that are scheduled based on different DCIs.

The control section 301 may determine a codebook to be used in a signal (channel) scheduled by the DCI based on the format of the DCI (detected DCI) to be transmitted.

Also, if a given format is used for the transmission or receiving processes for a particular signal (for example, message 3), and the format of DCI to transmit is the same as the given format, the control section 301 may determine using the codebook used to transmit or receive the specific signal as the codebook to use for the signal scheduled by that DCI.

Also, the control section 301 may allow the user terminal 20 to select a codebook based on the format of DCI and/or a given field included in DCI.

The control section 301 may assume that different codebooks are used for signals that differ in at least one of ports (the number of ports), layers (the number of layers), resource (the bandwidth etc.), beams, numerologies and so forth.

The control section 301 may exert control so that a number of codebooks are switched and used, or exert control so that multiple signals that are transmitted in different radio resources (for example, different time and/or frequency resources) all use separate codebooks.

The transmission signal generation section 302 generates downlink signals (downlink control signals, downlink data signals, downlink reference signals and so on) based on commands from the control section 301, and outputs these signals to the mapping section 303. The transmission signal generation section 302 can be constituted by a signal generator, a signal generating circuit or signal generating apparatus that can be described based on general understanding of the technical field to which the present invention pertains.

For example, the transmission signal generation section 302 generates DL assignments, which report downlink data allocation information, and/or UL grants, which report uplink data allocation information, based on commands from the control section 301. DL assignments and UL grants are both DCI, in compliance with DCI format. Also, the downlink data signals are subjected to the coding process, the modulation process and so on, by using coding rates and modulation schemes that are determined based on, for example, channel state information (CSI) from each user terminal 20.

The mapping section 303 maps the downlink signals generated in the transmission signal generation section 302 to predetermined radio resources based on commands from the control section 301, and outputs these to the transmitting/receiving sections 103. The mapping section 303 can be constituted by a mapper, a mapping circuit or mapping apparatus that can be described based on general understanding of the technical field to which the present invention pertains.

The received signal processing section 304 performs receiving processes (for example, demapping, demodulation, decoding and so on) of received signals that are input from the transmitting/receiving sections 103. Here, the received signals include, for example, uplink signals transmitted from the user terminal 20 (uplink control signals, uplink data signals, uplink reference signals, etc.). For the received signal processing section 304, a signal processor, a signal processing circuit or signal processing apparatus that can be described based on general understanding of the technical field to which the present invention pertains can be used.

The received signal processing section 304 outputs the decoded information acquired through the receiving processes, to the control section 301. For example, when a PUCCH to contain an HARQ-ACK is received, the received signal processing section 304 outputs this HARQ-ACK to the control section 301. Also, the received signal processing section 304 outputs the received signals and/or the signals after the receiving processes to the measurement section 305.

The measurement section 305 conducts measurements with respect to the received signals. The measurement section 305 can be constituted by a measurer, a measurement circuit or measurement apparatus that can be described based on general understanding of the technical field to which the present invention pertains.

For example, the measurement section 305 may perform Radio Resource Management (RRM) measurements, Channel State Information (CSI) measurements and so on, based on the received signals. The measurement section 305 may measure the received power (for example, Reference Signal Received Power (RSRP)), the received quality (for example, Reference Signal Received Quality (RSRQ), Signal to Interference plus Noise Ratio (SINR), etc.), Signal to Noise Ratio (SNR), the signal strength (for example, Received Signal Strength Indicator (RSSI)), transmission path information (for example, CSI), and so on. The measurement results may be output to the control section 301.

(User Terminal)

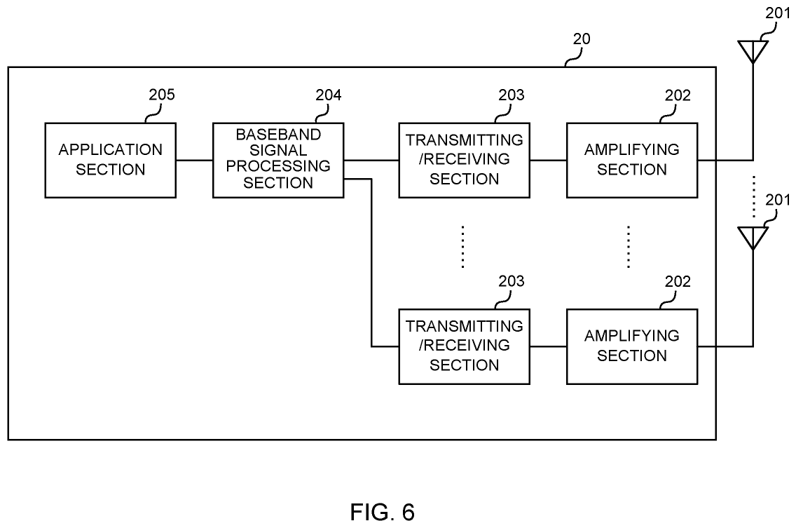

FIG. 6 is a diagram to show an exemplary overall structure of a user terminal according to one embodiment of the present invention. A user terminal 20 has a plurality of transmitting/receiving antennas 201, amplifying sections 202, transmitting/receiving sections 203, a baseband signal processing section 204 and an application section 205. Note that one or more transmitting/receiving antennas 201, amplifying sections 202 and transmitting/receiving sections 203 may be provided.

Radio frequency signals that are received in the transmitting/receiving antennas 201 are amplified in the amplifying sections 202. The transmitting/receiving sections 203 receive the downlink signals amplified in the amplifying sections 202. The received signals are subjected to frequency conversion and converted into the baseband signal in the transmitting/receiving sections 203, and output to the baseband signal processing section 204. A transmitting/receiving section 203 can be constituted by a transmitters/receiver, a transmitting/receiving circuit or transmitting/receiving apparatus that can be described based on general understanding of the technical field to which the present invention pertains. Note that a transmitting/receiving section 203 may be structured as a transmitting/receiving section in one entity, or may be constituted by a transmitting section and a receiving section.

The baseband signal processing section 204 performs, for the baseband signal that is input, an FFT process, error correction decoding, a retransmission control receiving process and so on. Downlink user data is forwarded to the application section 205. The application section 205 performs processes related to higher layers above the physical layer and the MAC layer, and so on. Also, in the downlink data, the broadcast information can be also forwarded to the application section 205.

Meanwhile, uplink user data is input from the application section 205 to the baseband signal processing section 204. The baseband signal processing section 204 performs a retransmission control transmission process (for example, an HARQ transmission process), channel coding, precoding, a discrete Fourier transform (DFT) process, an IFFT process and so on, and the result is forwarded to the transmitting/receiving sections 203. The baseband signal that is output from the baseband signal processing section 204 is converted into a radio frequency band in the transmitting/receiving sections 203. The radio frequency signals that are subjected to frequency conversion in the transmitting/receiving sections 203 are amplified in the amplifying sections 202, and transmitted from the transmitting/receiving antennas 201.

The transmitting/receiving sections 203 perform a transmission or receiving processes for signals based on downlink control information (UL grant, DL assignment, etc.).

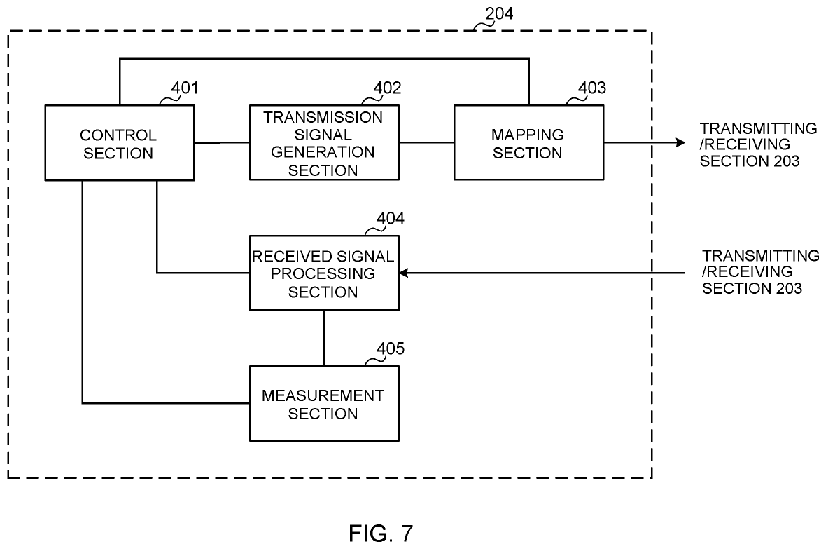

FIG. 7 is a diagram to show an exemplary functional structure of a user terminal according to one embodiment of the present invention. Note that, although this example primarily shows functional blocks that pertain to characteristic parts of the present embodiment, the user terminal 20 has other functional blocks that are necessary for radio communication as well.

The baseband signal processing section 204 provided in the user terminal 20 at least has a control section 401, a transmission signal generation section 402, a mapping section 403, a received signal processing section 404 and a measurement section 405. Note that these configurations have only to be included in the user terminal 20, and some or all of these configurations may not be included in the baseband signal processing section 204.

The control section 401 controls the whole of the user terminal 20. For the control section 401, a controller, a control circuit or control apparatus that can be described based on general understanding of the technical field to which the present invention pertains can be used.

The control section 401 controls, for example, generation of signals in the transmission signal generation section 402, allocation of signals in the mapping section 403, and so on. Furthermore, the control section 401 controls signal receiving processes in the received signal processing section 404, measurements of signals in the measurement section 405, and so on.

The control section 401 acquires the downlink control signals and downlink data signals transmitted from the radio base station 10, via the received signal processing section 404. The control section 401 controls the generation of uplink control signals and/or uplink data signals based on the results of deciding whether or not retransmission control is necessary for the downlink control signals and/or downlink data signals, and so on.

The control section 401 may determine to use different codebooks for transmission or receiving processes for multiple signals. These signals may be signals that are scheduled based on different DCIs. For example, these multiple signals may be each a DL signal (for example, a PDSCH signal). These signals may be each a UL signal (for example, a PUSCH signal).

The control section 401 may select a codebook to be used for the above processing based on the format of DCI (detected DCI) obtained from the received signal processing section 404.

Also, if a given format is used for the transmission or receiving processes for a particular signal (for example, message 3), and the detected DCI format is the same as the given format, the control section 401 may determine to use the codebook used for the transmission or receiving processes for the particular signal, as the codebook for the above processes.

The control section 401 may also select a codebook to be used for the above processing based on a given field included in the detected DCI. For example, when a given field indicates a specific value, the control section 401 may judge that the codebook used for the above processes is selected from a plurality of codebooks according to the specific value.

The control section 401 may determine to use different codebooks for the above processing for multiple signals corresponding to different waveforms. Furthermore, “waveform” may also be referred to as “waveform signal,” “signal in accordance with waveform,” “waveform of signal,” and so on.

The control section 401 may assume that different codebooks are used for signals that are different in at least one of ports (the number of ports), layers (the number of layers), resources (bandwidth, etc.), beams, numerologies and the like.

The control section 401 may determine to use different codebooks in the above processes for a plurality of signals, between which only a predetermined number of parameters (for example, one, two, and so on) are different among various parameters such as the waveform, ports (the number of ports), layers (the number of layers), resources (bandwidth, etc.), beams, numerologies and so forth, and all the rest of the parameters are the same. For example, the control section 401 may determine to use different codebooks in the above processes for a plurality of signals having the same number of layers and corresponding to different waveforms.

The control section 401 may exert control so that a number of codebooks are switched and used, or exert control so that multiple signals that are transmitted in different radio resources (for example, different time and/or frequency resources) all use separate codebooks.

Furthermore, when various kinds of information reported from the radio base station 10 are acquired via the received signal processing section 404, the control section 401 may update the parameters to use in control based on these pieces of information.

The transmission signal generation section 402 generates uplink signals (uplink control signals, uplink data signals, uplink reference signals, etc.) based on commands from the control section 401, and outputs these signals to the mapping section 403. The transmission signal generation section 402 can be constituted by a signal generator, a signal generating circuit or signal generation apparatus that can be described based on general understanding of the technical field to which the present invention pertains.

For example, the transmission information generation section 402 generates uplink control signals such as delivery acknowledgement information, channel state information (CSI) and so on, based on commands from the control section 401. Also, the transmission signal generation section 402 generates uplink data signals based on commands from the control section 401. For example, when a UL grant is included in a downlink control signal that is reported from the radio base station 10, the control section 401 commands the transmission signal generation section 402 to generate an uplink data signal.

The mapping section 403 maps the uplink signals generated in the transmission signal generation section 402 to radio resources based on commands from the control section 401, and output the result to the transmitting/receiving sections 203. The mapping section 403 can be constituted by a mapper, a mapping circuit or mapping apparatus that can be described based on general understanding of the technical field to which the present invention pertains.

The received signal processing section 404 performs receiving processes (for example, demapping, demodulation, decoding and so on) of received signals that are input from the transmitting/receiving sections 203. Here, the received signals include, for example, downlink signals (downlink control signals, downlink data signals, downlink reference signals and so on) that are transmitted from the radio base station 10. The received signal processing section 404 can be constituted by a signal processor, a signal processing circuit or signal processing apparatus that can be described based on general understanding of the technical field to which the present invention pertains. Also, the received signal processing section 404 can constitute the receiving section according to the present invention.

The received signal processing section 404 outputs the decoded information acquired through the receiving processes, to the control section 401. The received signal processing section 404 outputs, for example, broadcast information, system information, RRC signaling, DCI and so on, to the control section 401. Also, the received signal processing section 404 outputs the received signals and/or the signals after the receiving processes to the measurement section 405.

The measurement section 405 conducts measurements with respect to the received signals. The measurement section 405 can be constituted by a measurer, a measurement circuit or measurement apparatus that can be described based on general understanding of the technical field to which the present invention pertains.

For example, the measurement section 405 may perform RRM measurements, CSI measurements, and so on, based on the received signals. The measurement section 405 may measure the received power (for example, RSRP), the received quality (for example, RSRQ, SINR, SNR, etc.), the signal strength (for example, RSSI), transmission path information (for example, CSI) and so on. The measurement results may be output to the control section 401.

(Hardware Structure)

Note that the block diagrams that have been used to describe the above embodiments show blocks in functional units. These functional blocks (components) may be implemented in arbitrary combinations of hardware and/or software. Also, the method for implementing each functional block is not particularly limited. That is, each functional block may be realized by one piece of apparatus that is physically and/or logically aggregated, or may be realized by directly and/or indirectly connecting two or more physically and/or logically separate pieces of apparatus (via wire or wireless, for example) and using these multiple pieces of apparatus.

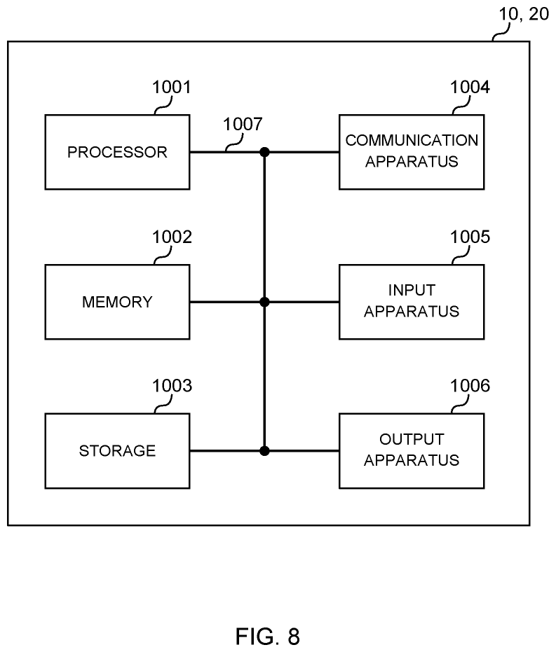

For example, the radio base station, user terminals and so on according to one embodiment of the present invention may function as a computer that executes the processes of the radio communication method of the present invention. FIG. 8 is a diagram to show an exemplary hardware structure of a radio base station and a user terminal according to one embodiment of the present invention. Physically, the above-described radio base stations 10 and user terminals 20 may be formed as a computer apparatus that includes a processor 1001, a memory 1002, a storage 1003, communication apparatus 1004, input apparatus 1005, output apparatus 1006 and a bus 1007.

Note that, in the following description, the word “apparatus” may be replaced by “circuit,” “device,” “unit” and so on. Note that the hardware structure of a radio base station 10 and a user terminal 20 may be designed to include one or more of each apparatus shown in the drawings, or may be designed not to include part of the apparatus.

For example, although only 1 processor 1001 is shown, a plurality of processors may be provided. Furthermore, processes may be implemented with 1 processor, or processes may be implemented in sequence, or in different manners, on one or more processors. Note that the processor 1001 may be implemented with one or more chips.

The functions of the radio base station 10 and the user terminal 20 are implemented by allowing hardware such as the processor 1001 and the memory 1002 to read predetermined software (programs), thereby allowing the processor 1001 to do calculations, the communication apparatus 1004 to communicate, and the memory 1002 and the storage 1003 to read and/or write data.

The processor 1001 may control the whole computer by, for example, running an operating system. The processor 1001 may be configured with a central processing unit (CPU), which includes interfaces with peripheral apparatus, control apparatus, computing apparatus, a register and so on. For example, the above-described baseband signal processing section 104 (204), call processing section 105 and so on may be implemented by the processor 1001.

Furthermore, the processor 1001 reads programs (program codes), software modules, data and so forth from the storage 1003 and/or the communication apparatus 1004, into the memory 1002, and executes various processes according to these. As for the programs, programs to allow computers to execute at least part of the operations of the above-described embodiments may be used. For example, the control section 401 of the user terminals 20 may be implemented by control programs that are stored in the memory 1002 and that operate on the processor 1001, and other functional blocks may be implemented likewise.

The memory 1002 is a computer-readable recording medium, and may be constituted by, for example, at least one of a Read Only Memory (ROM), an Erasable Programmable ROM (EPROM), an Electrically EPROM (EEPROM), a Random Access Memory (RAM) and/or other appropriate storage media. The memory 1002 may be referred to as a “register,” a “cache,” a “main memory” (primary storage apparatus) and so on. The memory 1002 can store executable programs (program codes), software modules and so on for implementing the radio communication methods according to embodiments of the present invention.

The storage 1003 is a computer-readable recording medium, and may be constituted by, for example, at least one of a flexible disk, a floppy (registered trademark) disk, a magneto-optical disk (for example, a compact disc (CD-ROM (Compact Disc ROM) and so on), a digital versatile disc, a Blu-ray (registered trademark) disk), a removable disk, a hard disk drive, a smart card, a flash memory device (for example, a card, a stick, a key drive, etc.), a magnetic stripe, a database, a server, and/or other appropriate storage media. The storage 1003 may be referred to as “secondary storage apparatus.”

The communication apparatus 1004 is hardware (transmitting/receiving apparatus) for allowing inter-computer communication by using wired and/or wireless networks, and may be referred to as, for example, a “network device,” a “network controller,” a “network card,” a “communication module” and so on. The communication apparatus 1004 may be configured to include a high frequency switch, a duplexer, a filter, a frequency synthesizer and so on in order to realize, for example, frequency division duplex (FDD) and/or time division duplex (TDD). For example, the above-described transmitting/receiving antennas 101 (201), amplifying sections 102 (202), transmitting/receiving sections 103 (203), communication path interface 106 and so on may be implemented by the communication apparatus 1004.

The input apparatus 1005 is an input device for receiving input from the outside (for example, a keyboard, a mouse, a microphone, a switch, a button, a sensor and so on). The output apparatus 1006 is an output device for allowing sending output to the outside (for example, a display, a speaker, an Light Emitting Diode (LED) lamp and so on). Note that the input apparatus 1005 and the output apparatus 1006 may be provided in an integrated structure (for example, a touch panel).

Furthermore, these pieces of apparatus, including the processor 1001, the memory 1002 and so on are connected by the bus 1007 so as to communicate information. The bus 1007 may be formed with a single bus, or may be formed with buses that vary between pieces of apparatus.

Also, the radio base station 10 and the user terminal 20 may be structured to include hardware such as a microprocessor, a digital signal processor (DSP), an Application-Specific Integrated Circuit (ASIC), a Programmable Logic Device (PLD), an Field Programmable Gate Array (FPGA) and so on, and part or all of the functional blocks may be implemented by the hardware. For example, the processor 1001 may be implemented with at least one of these pieces of hardware.

(Variations)

Note that the terminology used in this specification and the terminology that is needed to understand this specification may be replaced by other terms that convey the same or similar meanings. For example, “channels” and/or “symbols” may be replaced by “signals” (or “signaling”). Also, “signals” may be “messages.” A reference signal may be abbreviated as an “RS,” and may be referred to as a “pilot,” a “pilot signal” and so on, depending on which standard applies. Furthermore, a “component carrier (CC)” may be referred to as a “cell,” a “frequency carrier,” a “carrier frequency” and so on.

Furthermore, a radio frame may be comprised of one or more periods (frames) in the time domain. Each of one or more periods (frames) constituting a radio frame may be referred to as a “subframe.” Furthermore, a subframe may be comprised of one or multiple slots in the time domain. A subframe may be a fixed time duration (for example, 1 ms) not dependent on the numerology.

Furthermore, a slot may be comprised of one or more symbols in the time domain (Orthogonal Frequency Division Multiplexing (OFDM) symbols, Single Carrier Frequency Division Multiple Access (SC-FDMA) symbols, and so on). Also, a slot may be a time unit based on numerology. Also, a slot may include a plurality of minislots. Each minislot may be comprised of one or more symbols in the time domain. Also, a minislot may be referred to as a “subslot.”

A radio frame, a subframe, a slot, a minislot and a symbol all represent the time unit in signal communication. A radio frame, a subframe, a slot, a minislot and a symbol may be each called by other applicable names. For example, 1 subframe may be referred to as a “transmission time interval (TTI),” or a plurality of consecutive subframes may be referred to as a “TTI,” or 1 slot or mini-slot may be referred to as a “TTI.” That is, a subframe and/or a TTI may be a subframe (1 ms) in existing LTE, may be a shorter period than 1 ms (for example, 1 to 13 symbols), or may be a longer period of time than 1 ms. Note that the unit to represent the TTI may be referred to as a “slot,” a “mini slot” and so on, instead of a “subframe.”

Here, a TTI refers to the minimum time unit of scheduling in radio communication, for example. For example, in LTE systems, a radio base station schedules the radio resources (such as the frequency bandwidth and transmission power that can be used in each user terminal) to allocate to each user terminal in TTI units. Note that the definition of TTIs is not limited to this.

The TTI may be the transmission time unit of channel-encoded data packets (transport blocks), code blocks and/or codewords, or may be the unit of processing in scheduling, link adaptation and so on. Note that, when a TTI is given, the period of time (for example, the number of symbols) in which transport blocks, code blocks and/or codewords are actually mapped may be shorter than the TTI.

Note that, when 1 slot or 1 minislot is referred to as a “TTI,” one or more TTIs (that is, one or multiple slots or one or more minislots) may be the minimum time unit of scheduling. Also, the number of slots (the number of minislots) to constitute this minimum time unit of scheduling may be controlled.

A TTI having a time duration of 1 ms may be referred to as a “normal TTI” (TTI in LTE Rel. 8 to 12), a “long TTI,” a “normal subframe,” a “long subframe,” and so on. A TTI that is shorter than a normal TTI may be referred to as a “shortened TTI,” a “short TTI,” a “partial TTI” (or a “fractional TTI”), a “shortened subframe,” a “short subframe,” a “mini-slot,” a “sub-slot” and so on.

Note that a long TTI (for example, a normal TTI, a subframe, etc.) may be replaced with a TTI having a time duration exceeding 1 ms, and a short TTI (for example, a shortened TTI) may be replaced with a TTI having a TTI length less than the TTI length of a long TTI and not less than 1 ms.

A resource block (RB) is the unit of resource allocation in the time domain and the frequency domain, and may include one or a plurality of consecutive subcarriers in the frequency domain. Also, an RB may include one or more symbols in the time domain, and may be 1 slot, 1 minislot, 1 subframe or 1 TTI in length. 1 TTI and 1 subframe each may be comprised of one or more resource blocks. Note that one or more RBs may be referred to as a “physical resource block (Physical RB (PRB)),” a “subcarrier group (SCG),” a “resource element group (REG),” a “PRB pair,” an “RB pair” and so on.

Furthermore, a resource block may be comprised of one or more resource elements (REs). For example, 1 RE may be a radio resource field of 1 subcarrier and 1 symbol.

Note that the structures of radio frames, subframes, slots, minislots, symbols and so on described above are merely examples. For example, configurations pertaining to the number of subframes included in a radio frame, the number of slots included per subframe or radio frame, the number of mini-slots included in a slot, the number of symbols and RBs included in a slot or a mini-slot, the number of subcarriers included in an RB, the number of symbols in a TTI, the symbol duration, the length of cyclic prefixes (CPs) and so on can be variously changed.

Also, the information and parameters described in this specification may be represented in absolute values or in relative values with respect to predetermined values, or may be represented using other applicable information. For example, a radio resource may be specified by a predetermined index.

The names used for parameters and so on in this specification are in no respect limiting. For example, since various channels (Physical Uplink Control CHannel (PUCCH), Physical Downlink Control CHannel (PDCCH) and so on) and information elements can be identified by any suitable names, the various names assigned to these individual channels and information elements are in no respect limiting.

The information, signals and/or others described in this specification may be represented by using a variety of different technologies. For example, data, instructions, commands, information, signals, bits, symbols and chips, all of which may be referenced throughout the herein-contained description, may be represented by voltages, currents, electromagnetic waves, magnetic fields or particles, optical fields or photons, or any combination of these.

Also, information, signals and so on can be output from higher layers to lower layers and/or from lower layers to higher layers. Information, signals and so on may be input and/or output via a plurality of network nodes.

The information, signals and so on that are input and/or output may be stored in a specific location (for example, in a memory), or may be managed in a control table. The information, signals and so on to be input and/or output can be overwritten, updated or appended. The information, signals and so on that are output may be deleted. The information, signals and so on that are input may be transmitted to other pieces of apparatus.

Reporting of information is by no means limited to the examples/embodiments described in this specification, and other methods may be used as well. For example, reporting of information may be implemented by using physical layer signaling (for example, downlink control information (DCI), uplink control information (UCI)), higher layer signaling (for example, RRC (Radio Resource Control) signaling, broadcast information (the master information block (MIB), system information blocks (SIBs) and so on), MAC (Medium Access Control) signaling and so on), and other signals and/or combinations of these.

Note that physical layer signaling may be referred to as “L1/L2 (Layer 1/Layer 2) control information (L1/L2 control signals),” “L1 control information (L1 control signal)” and so on. Also, RRC signaling may be referred to as “RRC messages,” and can be, for example, an RRC connection setup message, RRC connection reconfiguration message, and so on. Also, MAC signaling may be reported using, for example, MAC control elements (MAC CEs (Control Elements)).

Also, reporting of predetermined information (for example, reporting of information to the effect that “X holds”) does not necessarily have to be sent explicitly, and can be sent in an implicit way (for example, by not reporting this piece of information, by reporting another piece of information, and so on). Decisions may be made in values represented by 1 bit (0 or 1), may be made in Boolean values that represent true or false, or may be made by comparing numerical values (for example, comparison against a predetermined value).

Software, whether referred to as “software,” “firmware,” “middleware,” “microcode” or “hardware description language,” or called by other names, should be interpreted broadly, to mean instructions, instruction sets, code, code segments, program codes, programs, subprograms, software modules, applications, software applications, software packages, routines, subroutines, objects, executable files, execution threads, procedures, functions and so on.

Also, software, commands, information and so on may be transmitted and received via communication media. For example, when software is transmitted from a website, a server or other remote sources by using wired technologies (coaxial cables, optical fiber cables, twisted-pair cables, digital subscriber lines (DSL) and so on) and/or wireless technologies (infrared radiation, microwaves and so on), these wired technologies and/or wireless technologies are also included in the definition of communication media.

The terms “system” and “network” as used herein are used interchangeably.

As used herein, the terms “base station (BS),” “radio base station,” “eNB,” “gNB,” “cell,” “sector,” “cell group,” “carrier,” and “component carrier” may be used interchangeably. A base station may be referred to as a “fixed station,” “NodeB,” “eNodeB (eNB),” “access point,” “transmission point,” “receiving point,” “femto cell,” “small cell” and so on.

A base station can accommodate one or more (for example, 3) cells (also referred to as “sectors”). When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part or all of the coverage area of a base station and/or a base station subsystem that provides communication services within this coverage.

As used herein, the terms “mobile station (MS)” “user terminal,” “user equipment (UE)” and “terminal” may be used interchangeably. A base station may be referred to as a “fixed station,” “NodeB,” “eNodeB (eNB),” “access point,” “transmission point,” “receiving point,” “femto cell,” “small cell” and so on.

A mobile station may be referred to, by a person skilled in the art, as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client” or some other suitable terms.

Furthermore, the radio base stations in this specification may be interpreted as user terminals. For example, each aspect/embodiment of the present invention may be applied to a configuration in which communication between a radio base station and a user terminal is replaced with communication among a plurality of user terminals (Device-to-Device (D2D)). In this case, user terminals 20 may have the functions of the radio base stations 10 described above. In addition, terms such as “uplink” and “downlink” may be interpreted as “side.” For example, an “uplink channel” may be interpreted as a “side channel.”

Likewise, the user terminals in this specification may be interpreted as radio base stations. In this case, the radio base stations 10 may have the functions of the user terminals 20 described above.

Certain actions which have been described in this specification to be performed by base stations may, in some cases, be performed by their upper nodes. In a network comprised of one or more network nodes with base stations, it is clear that various operations that are performed so as to communicate with terminals can be performed by base stations, one or more network nodes (for example, Mobility Management Entities (MMEs), Serving-Gateways (S-GWs) and so on may be possible, but these are not limiting) other than base stations, or combinations of these.

The aspects/embodiments illustrated in this specification may be used individually or in combinations, which may be switched depending on the mode of implementation. The order of processes, sequences, flowcharts and so on that have been used to describe the aspects/embodiments herein may be re-ordered as long as inconsistencies do not arise. For example, although various methods have been illustrated in this specification with various components of steps in exemplary orders, the specific orders that are illustrated herein are by no means limiting.

The aspects/embodiments illustrated in this specification may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), Future Radio Access (FRA), New-RAT (Radio Access Technology), New Radio (NR), New radio access (NX), Future generation radio access (FX), GSM (registered trademark) (Global System for Mobile communications), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication systems and/or next-generation systems that are enhanced based on these.

The phrase “based on” as used in this specification does not mean “based only on,” unless otherwise specified. In other words, the phrase “based on” means both “based only on” and “based at least on.”

Reference to elements with designations such as “first,” “second” and so on as used herein does not generally limit the number/quantity or order of these elements. These designations are used herein only for convenience, as a method for distinguishing between two or more elements. In this way, reference to the first and second elements does not imply that only 2 elements may be employed, or that the first element must precede the second element in some way.

The terms “judge” and “determine” as used herein may encompass a wide variety of actions. For example, to “judge” and “determine” as used herein may be interpreted to mean making judgements and determinations related to calculating, computing, processing, deriving, investigating, looking up (for example, searching a table, a database or some other data structure), ascertaining and so on. Furthermore, to “judge” and “determine” as used herein may be interpreted to mean making judgements and determinations related to receiving (for example, receiving information), transmitting (for example, transmitting information), inputting, outputting, accessing (for example, accessing data in a memory) and so on. In addition, to “judge” and “determine” as used herein may be interpreted to mean making judgements and determinations related to resolving, selecting, choosing, establishing, comparing and so on. In other words, to “judge” and “determine” as used herein may be interpreted to mean making judgements and determinations related to some action.

As used herein, the terms “connected” and “coupled,” or any variation of these terms, mean all direct or indirect connections or coupling between two or more elements, and may include the presence of one or more intermediate elements between 2 elements that are “connected” or “coupled” to each other. The coupling or connection between the elements may be physical, logical or a combination of these. For example, “connection” may be interpreted as “access.”

As used herein, when 2 elements are connected, these elements may be considered “connected” or “coupled” to each other by using one or more electrical wires, cables and/or printed electrical connections, and, as a number of non-limiting and non-inclusive examples, by using electromagnetic energy, such as electromagnetic energy having wavelengths in the radio frequency, microwave and optical (both visible and invisible) regions.

In the present specification, the phrase “A and B are different” may mean “A and B are different from each other.” The terms such as “leave” “coupled” and the like may be interpreted as well.

When terms such as “include,” “comprise” and variations of these are used in this specification or in claims, these terms are intended to be inclusive, in a manner similar to the way the term “provide” is used. Furthermore, the term “or” as used in this specification or in claims is intended to be not an exclusive disjunction.

Now, although the present invention has been described in detail above, it should be obvious to a person skilled in the art that the present invention is by no means limited to the embodiments described herein. The present invention can be implemented with various corrections and in various modifications, without departing from the spirit and scope of the present invention defined by the recitations of claims. Consequently, the description herein is provided only for the purpose of explaining examples, and should by no means be construed to limit the present invention in any way.

1. A user terminal comprising:
a transmitting/receiving section that performs transmitting or receiving processes for signals based on downlink control information; and
a control section that decides to use different codebooks for the processes for a plurality of signals.

2. The user terminal according to claim 1, wherein the control section selects a codebook to use for the processes based on a format of the downlink control information.

3. The user terminal according to claim 2, wherein, if a given format is used for transmitting or receiving processes for a particular signal and the format of the downlink control information is the same as a given format, the control section decides to use the codebook used for transmitting or receiving processes for the particular signal as the codebook to use for the processes.

4. The user terminal according to claim 1, wherein the control section selects a codebook used for the process based on a given field included in the downlink control information.

5. The user terminal according to claim 4, wherein, if the given field indicates a specific value, the control section judges that the codebook to use for the processes is selected according to the specific value from a plurality of codebooks.

6. The user terminal according to claim 1, wherein the control section decides to use different codebooks for the processes for the plurality of signals corresponding to different waveforms.

7. A radio communication method for a user terminal, comprising the steps of:
performing transmitting or receiving processes for signals based on downlink control information; and
deciding to use different codebooks for the processes for a plurality of signals.

8. The user terminal according to claim 2, wherein the control section decides to use different codebooks for the processes for the plurality of signals corresponding to different waveforms.

9. The user terminal according to claim 3, wherein the control section decides to use different codebooks for the processes for the plurality of signals corresponding to different waveforms.

10. The user terminal according to claim 4, wherein the control section decides to use different codebooks for the processes for the plurality of signals corresponding to different waveforms.

11. The user terminal according to claim 5, wherein the control section decides to use different codebooks for the processes for the plurality of signals corresponding to different waveforms.
